(19) United States
(12) Patent Application Publication
(10) Pub. No.: US 2011/0166314 A1
(43) Pub. Date: Jul. 7, 2011

(54) ETHYLENE-BASED RESIN AND FILM

(75) Inventor: Yoshinobu Nozue, Ichihara-shi (JP)

(73) Assignee: SUMITOMO CHEMICAL CO., LTD., Chuo-ku, Tokyo (JP)

(21) Appl. No.: 13/063,290

(22) PCT Filed: Sep. 17, 2009
(86) PCT No.: PCT/JP2009/066836

§ 371 Date: Mar. 10, 2011

(30) Foreign Application Priority Data
Sep. 19, 2008 (JP) 2008-240756
Nov. 19, 2008 (JP) 2008-295423

(51) Int. Cl. C08F 10/02; B29C 47/00

(52) U.S. Cl. 526/352; 264/176.1

(57) ABSTRACT

The purpose of the invention is to provide an ethylene-based resin having a transparency enhanced without excessively lowering an impact strength, which a linear low-density polyethylene has. There is provided an ethylene-based resin satisfying all of the following conditions:
(a) its density ranges from 890 to 930 kg/m³,
(b) its melt flow rate (MFR) ranges from 0.1 to 10 g/10 min,
(c) its activation energy (Ea) of flow is less than 50 kJ/mol,
(d) its Mz/Mw is not less than 3.5,
(e) its (Mz/Mw)/(Mw/Mn) is not less than 0.9, and
(f) its proportion of a resin amount eluted at 100° C. or more as measured by a temperature rise elution fractionation method is less than 1 wt %, provided that a total amount of the ethylene-based resin eluted up to 140° C. is 100 wt %.

### FIELD OF THE INVENTION

The present invention relates to an ethylene-based resin and a film.

### BACKGROUND OF THE INVENTION

As a packaging material used for packaging of foods, medicines, miscellaneous daily goods, and the like, in many cases there is used a film or sheet produced by extrusion molding of an ethylene-based resin. In ethylene-based resins, a linear copolymer of ethylene and an α-olefin, the so-called linear low-density polyethylene is excellent in impact strength as compared with high-pressure process low-density polyethylene. Therefore, a packaging material consisting of linear low-density polyethylene can be made thinner than a packaging material consisting of high-pressure process low-density polyethylene.

On the one hand, in some cases linear low-density polyethylene is inferior in transparency to high-pressure process low-density polyethylene. Some of packaging materials are requested to have transparency, and hence various methods for improving transparency of linear low-density polyethylene are being studied. For example, it is proposed to provide a resin composition wherein 5 to 30 weight % of high-pressure process low-density polyethylene is incorporated in linear low-density polyethylene (cf. Patent Documents 1 and 2).

[Patent Document 1] JP-B-62-3177

[Patent Document 2] JP-A-11-181173

### BRIEF SUMMARY OF THE INVENTION

However, in the above-mentioned resin composition, transparency was improved by incorporating high-pressure process low-density polyethylene, but impact strength decreased highly in some cases, and sufficiently satisfying performances were not necessarily obtained.

Under such situations, the present invention solves the problems as mentioned above, and provides an ethylene-based resin having transparency enhanced without excessively lowering the impact strength, which linear low-density polyethylene has, and a film produced by extrusion molding of the resin.

### Advantages of the Invention

The present invention can provide an ethylene-based resin having transparency enhanced without excessively lowering the impact strength, which linear low-density polyethylene has, and a film produced by extrusion molding of the resin.

### DETAILED DESCRIPTION OF THE INVENTION

The first aspect of the present invention relates to an ethylene-based resin satisfying all of the following conditions:
(a) its density ranges from 890 to 930 kg/m³,
(b) its melt flow rate (MFR) ranges from 0.1 to 10 g/10 min,
(c) its activation energy (Ea) of flow is less than 50 kJ/mol,
(d) its Mz/Mw is not less than 3.5,
(e) its (Mz/Mw)/(Mw/Mn) is not less than 0.9, and
(f) its proportion of a resin amount eluted at 100° C. or more as measured by a temperature rise elution fractionation method is less than 1 wt %, provided that a total amount of the ethylene-based resin eluted up to 140° C. is 100 wt %.

The second aspect of the present invention relates to a film produced by an extrusion molding of the above-mentioned ethylene-based resin.

The ethylene-based resin of the present invention is a copolymer resin containing a monomer unit based on ethylene and a monomer unit based on an α-olefin. The α-olefin includes propylene, 1-butene, 1-pentene, 1-hexene, 1-heptene, 1-octene, 1-nonene, 1-decene, 1-dodecene, 4-methyl-1-pentene, 4-methyl-1-hexene, and the like. These may be used singly or in a combination of two or more kinds. The α-olefin is preferably an α-olefin having 3 to 20 carbon atoms, more preferably an α-olefin having 4 to 8 carbon atoms, and further more preferably at least one kind of α-olefin selected from 1-butene, 1-hexene, and 4-methyl-1-pentene.

The ethylene-based resin may have a monomer unit based on another monomer in a range wherein effects of the present invention are not impaired, in addition to the above-mentioned monomer unit based on ethylene and monomer unit based on an α-olefin. The other monomer includes, for example, a conjugated diene (for example, butadiene or isoprene), a non-conjugated diene (for example, 1,4-pentadiene), acrylic acid, acrylic acid ester (for example, methyl acrylate or ethyl acrylate), methacrylic acid, methacrylic acid ester (for example, methyl methacrylate or ethyl methacrylate), vinyl acetate, and the like.

The ethylene-based resin includes, for example, ethylene-1-butene copolymer resin, ethylene-1-hexene copolymer resin, ethylene-4-methyl-1-pentene copolymer resin, ethylene-1-octene copolymer resin, ethylene-1-butene-1-hexene copolymer resin, ethylene-1-butene-4-methyl-1-pentene copolymer resin, ethylene-1-butene-1-octene copolymer resin, and the like. It is preferably ethylene-1-butene copolymer resin, ethylene-1-hexene copolymer resin, ethylene-4-methyl-1-pentene copolymer resin, or ethylene-1-butene-1-hexene copolymer resin.

The content of a monomer unit based on ethylene in the ethylene-based resin is usually 50 to 99.5 weight % and preferably 80 to 99 weight % based on the total weight (100 weight %) of the ethylene-based resin. In addition, the content of a monomer unit based on an α-olefin is usually 0.5 to 50 weight % and preferably 1 to 20 weight % based on the total weight. (100 weight %) of the ethylene-based resin.

The density (its unit is kg/m³) of the ethylene-based resin ranges from 890 to 930 kg/m³ (condition (a)). The density of the ethylene-based resin is preferably not less than 890 kg/m³ and more preferably not less than 900 kg/m³ from the viewpoint of enhancing rigidity. In addition, it is preferably not more than 925 kg/m³ and more preferably not more than 920 kg/m³ from the viewpoint of enhancing transparency and impact strength. The density is measured in accordance with the underwater substitution method as stipulated in JIS K7112-1980 after conducting of the annealing as stated in JIS K6760-1995.

The melt flow rate (MFR; its unit is g/10 min.) of the ethylene-based resin ranges from 0.1 to 10 g/10 min (condition (b)). The MFR of the ethylene-based resin is preferably not less than 0.5 g/10 min. and more preferably not less than 0.8 g/10 min. from the viewpoint of lowering the extrusion load at the time of molding. In addition, it is preferably not more than 5 g/10 min. and more preferably not more than 3 g/10 min. and most preferably not more than 2 g/10 min. from the viewpoint of enhancing transparency and impact strength. The melt flow rate is a value measured by A method under the conditions of 190° C. temperature and 21.18 N load in accordance with the method as stipulated in JIS K7210-1995.

The activation energy (Ea; its unit is kJ/mol) of flow of the ethylene-based resin is less than 50 kJ/mol (condition (c)). The Ea of the ethylene-based resin is preferably not more than 40 kJ/mol and more preferably not more than 35 kJ/mol from the viewpoint of enhancing transparency and impact strength.

Activation energy (Ea) of flow is a numerical value calculated by Arrhenius type equation from the shift factor (aᵣ) in preparing a master curve showing the dependency of melting complex viscosity (unit: Pa·sec) on angular frequency (unit: rad/sec) at 190° C. on the basis of temperature-time superposition principle, and is a value obtained by the method as stated below. That is, with regard to four temperatures including 190° C. among temperatures of 130° C., 150° C., 170° C., 190° C., and 210° C., a shift factor (aᵣ) at each temperature (T) is obtained by superposing melting complex viscosity-angular frequency curves of an ethylene-based resin at the respective temperatures (T, unit: ° C.) on melting complex viscosity-angular frequency curve of the ethylene-based resin at 190° C. on the basis of temperature-time superposition principle about every melting complex viscosity-angular frequency curve at each temperature (T), and then a linear approximate equation (the undermentioned formula (I)) of [ln (aᵣ)] and [1/(T+273.16)] is calculated by the least-square method from the plot between the temperatures (T) and the shift factor (aᵣ) at each temperature (T). Subsequently, Ea is obtained from the gradient m of the primary expression and the undermentioned formula (II).

ln(aᵣ)=m(1/(T+273.16))+n (I)

Ea=|0.008314×m (II)
aᵣ: shift factor
Ea: activation energy of flow (unit: kJ/mol)
T: temperature (unit: ° C.)
   For the above calculations a commercially available calculation software may be used, and the calculation software includes Rhios V.4.4.4 manufactured by Rheometrics Co. and the like.

In addition, the shift factor (aᵣ) is shift amount when both logarithmic curves of melting complex viscosity-angular frequency at the respective temperatures (T) are shifted to the direction of log (Y)=−log (X) axis, provided that Y-axis indicates melting complex viscosity and X-axis indicates angular frequency, and are superposed on melting complex viscosity-angular frequency curve at 190° C. In the superposition, both logarithmic curves of melting complex viscosity-angular frequency at the respective temperatures (T) are shifted to aᵣ times in angular frequency and to 1/aᵣ times in melting complex viscosity.

In addition, the correlation coefficient in calculating the linear approximate equation (I) by the least-square method from the plot of shift factors at four temperatures including 190° C. among temperatures of 130° C., 150° C., 170° C., 190° C., and 210° C., and the temperatures, is usually not less than 0.99.

Measurement of the above melting complex viscosity-angular frequency curve is carried out usually under the conditions of geometry: parallel plates, plate diameter: 25 mm, distance between plates: 1.2 to 2 mm, strain: 5%, and angular frequency: 0.1 to 100 rad/sec by use of a viscoelasticity measuring apparatus (for example, Rheometrics Mechanical Spectrometer RMS-800 manufactured by Rheometrics Co., or the like). In addition, the measurement is carried out under nitrogen atmosphere, and it is preferable to previously incorporate an adequate amount (for example, 1,000 ppm) of an antioxidant in a measurement sample.

The ratio (hereinafter, sometimes referred to as “Mz/Mw”) of Z average molecular weight (hereinafter, sometimes referred to as “Mz”) to weight average molecular weight (hereinafter, sometimes referred to as “Mw”) of the ethylene-based resin is not less than 3.5 (condition (d)). From the viewpoint of impact strength, Mz/Mw is preferably not less than 4.5. Furthermore, from the viewpoint of processability and impact strength, Mz/Mw is preferably not more than 25, more preferably not more than 20, further preferably not more than 15, further more preferably not more than 10, and most preferably not more than 7.

The ratio (hereinafter, sometimes referred to as “Mw/Mn”) of weight average molecular weight (hereinafter, sometimes referred to as “Mw”) to number average molecular weight (hereinafter, sometimes referred to as “Mn”) of the ethylene-based resin is preferably not less than 3 and more preferably not less than 4 from the viewpoint of enhancing processability. Furthermore, from the viewpoint of mechanical strength of the resultant film, Mw/Mn is preferably not more than 15, more preferably not more than 10, further more preferably not more than 8, and most preferably not more than 5. In addition, Mw/Mn and Mz/Mw are values calculated from number average molecular weight (Mn), weight average molecular weight (Mw), and Z average molecular weight (Mz), which are measured by gel permeation chromatograph (GPC) method.

Mw/Mn and Mz/Mw of the ethylene-based resin can be controlled by the method as mentioned below. For example, in the case of producing the ethylene-based resin of the present invention by conducting continuously the step of producing a component having a high molecular weight and the step of producing a component having a low molecular weight, there can be used a method of changing hydrogen concentration or polymerization temperature in the respective production steps. Concretely, in the case where the conditions in producing a component having a high molecular weight are made constant, when hydrogen concentration or polymerization temperature in producing a component having a low molecular weight is made higher, Mw/Mn of the resultant ethylene-based resin becomes larger. Similarly, Mz/Mw of the ethylene-based resin can be made larger by lowering hydrogen concentration or polymerization temperature in producing a component having a high molecular weight. Furthermore, Mz/Mw of the ethylene-based resin can be made larger by lengthening the time of step of producing a component having a high molecular weight to increase the content of a high molecular weight component in the ethylene-based resin.

Mz/Mw indicates molecular weight distribution of a high molecular weight component contained in the ethylene-based resin. The fact that Mz/Mw is smaller as compared with Mw/Mn, means that molecular weight distribution of a high molecular weight component is narrow, and that the proportion of a component having a very high molecular weight is little, whereas the fact that Mz/Mw is larger as compared with Mw/Mn, means that molecular weight distribution of a high molecular weight component is broad, and that the proportion of a component having a very high molecular weight is much. In the ethylene-based resin of the present invention, (Mz/Mw)/(Mw/Mn) is not less than 0.9 (condition (e)), preferably (Mz/Mw)/(Mw/Mn) is not less than 1. In the ethylene-based resin of the present invention,

(Mz/Mw)/(Mw/Mn) is preferably not more than 2.5, more preferably not more than 1.5.

In the ethylene-based resin of the present invention, the proportion of a resin amount eluted at 100° C. or more as measured by a temperature rise elution fractionation method is less than 1 wt %, provided that a total amount of the ethylene-based resin eluted up to 140° C. is 100 wt % (condition (f)).

A resin component eluted at 100° C. or more by a temperature rise elution fractionation method in the ethylene-based resin means a high-density component. When the ethylene-based resin contains a high-density component and a low-density component, these components have different crystallization initiation temperatures, and hence at the time of film formation surface roughening is caused, and accordingly the resultant film becomes inferior in transparency. The proportion of a resin amount eluted at 100° C. or more in a temperature rise elution fractionation method is preferably less than 0.5 wt %, and more preferably less than 0.1 wt %.

The proportion of a resin amount eluted at 100° C. or more as measured by a temperature rise elution fractionation method in the ethylene-based resin can be controlled as follows. For example, in the case of producing the ethylene-based resin of the present invention by conducting continuously the step of producing a component having a high molecular weight and the step of producing a component having a low molecular weight, there can be used a method of changing α-olefin concentration to ethylene concentration in the respective production steps. Concretely, by increasing the ratio of α-olefin concentration to ethylene concentration in a polymerization reaction vessel, the proportion of short chain branched structure to be introduced in polymer chains can be increased. A polymer having molecular structure high in the proportion of short chain branched structure as mentioned above has crystal structure thin in crystal thickness, and hence can be dissolved at a lower temperature. Furthermore, by producing a component having a high molecular weight and a component having a low molecular weight by use of two kinds of complexes without controlling the ratio of α-olefin concentration to ethylene concentration, the ethylene-based resin of the present invention can be produced. In this case, selecting a complex that gives higher copolymerizability of an α-olefin with ethylene, can provide an ethylene-based resin melting at a lower temperature.

The ethylene-based resin of the present invention can be produced by combining two or more kinds of publicly-known catalysts for olefin polymerization among Ziegler catalysts, metallocene type catalysts, and the like, which give highly different molecular weights among them in the comparison of polymerization of ethylene and an α-olefin under the same polymerization conditions by use of each catalyst. Furthermore, it can be produced by copolymerizing ethylene and an α-olefin by publicly-known polymerization methods such as liquid phase polymerization method, slurry polymerization method, gas phase polymerization method, high pressure ion polymerization method, and the like, which include the step of producing an ethylene-α-olefin copolymer having a high molecular weight by use of one of publicly-known catalysts for olefin polymerization, which can produce an ethylene-α-olefin copolymer having a high molecular weight, and the step of producing an ethylene-α-olefin copolymer having a low molecular weight, and which use plural reaction vessels. These polymerization methods may be either one of batch polymerization method and continuous polymerization method.

When the ethylene-based resin of the present invention is produced by use of plural reaction vessels, a high molecular weight component and a low molecular weight component are produced continuously respectively with different reaction vessels. When polymerization is conducted in continuous process as mentioned above, among polymer particles there are those which pass through certain reaction vessels for a very short time (hereinafter called as short path polymer particles sometimes). In order to prevent generation of such short path polymer particles, when the ethylene-based resin of the present invention is produced in continuous process by use of plural reaction vessels, it is preferable to produce a high molecular weight component in the first polymerization vessel and subsequently produce a low molecular weight component with two or more reaction vessels connected. On the one hand, when the ethylene-based resin of the present invention is produced in batch polymerization, a low molecular weight component and a high molecular weight component can be produced respectively in two reaction vessels.

When the ethylene-based resin of the present invention is produced in batch polymerization, a high molecular weight component and a low molecular weight component can be sequentially produced also by changing hydrogen concentration with time in one reaction vessel without using plural reaction vessels.

When the ethylene-based resin of the present invention is produced by use of two or more kinds of catalysts for olefin polymerization, as the catalysts for olefin polymerization to be used, it is preferable to polymerize ethylene and an α-olefin with a combination of catalysts, which give highly different molecular weights among them in the comparison under the same polymerization conditions by use of each catalyst. Furthermore, with regard to the catalysts for polymerization, as either catalyst of a catalyst for producing a high molecular weight component and a catalyst for producing a low molecular weight component, it is important to select a catalyst, which can produce an ethylene-based resin having little long chain branched structure, the activation energy of flow of which is less than 50 kJ/mol. When long chain branched structure is present in a high molecular weight component, there is a trend toward the fact that surface roughening is caused on film surface by a component having a long relaxation time and film transparency is deteriorated. Moreover, when long chain branched structure is present in a low molecular weight component, decrease in impact strength tends to be caused.

When the ethylene-based resin of the present invention is produced with one kind of a polymerization catalyst, a suitable catalyst includes, for example, a solid catalyst component containing 0.8 to 1.4 wt % of titanium atom, magnesium atom, halogen atom, and 15 to 50 wt % of an ester compound, and having a specific surface area by BET method of not more than 80 m²/g. The ester compound contained in the solid catalyst component is preferably a dialkyl phthalate from the viewpoint of polymerization activity. The solid catalyst component can be obtained as a contact product of (a) a solid component obtained by reducing (ii) a titanium compound represented by the undermentioned general formula [I] with (iii) an organic magnesium compound in the presence of (i) an organic silicon compound having Si—O bond, (b) a halogenated compound, and (c) a phthalic acid derivative.

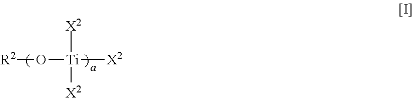

In the formula [I], a is a number of 1 to 20, R² stands for a hydrocarbon group having 1 to 20 carbon atoms, each of X² stands for a halogen atom or a hydrocarbonoxy group having 1 to 20 carbon atoms, and all X² may be the same or different with each other.

The organic silicon compound having Si—O bond (i) includes a compound represented by the undermentioned general formula.)

Si(OR¹⁰)ₜR¹¹₄₋ₜ,

R¹²(R¹³₂SiO)ᵤSiR¹⁴₃, or

(R¹⁵₂SiO)ᵥ

In the formula, R¹⁰ stands for a hydrocarbon group having 1 to 20 carbon atoms; R¹¹, R¹², R¹³, R¹⁴ and R¹⁵ independently stands for a hydrocarbon group having 1 to 20 carbon atoms or a hydrogen atom; t is an integer satisfying 0<t≦4; u is an integer of 1 to 1000; and v is an integer of 2 to 1000.

The organic silicon compound having Si—O bond (i) includes, for example, tetramethoxy silane, dimethyldimethoxy silane, tetraethoxy silane, triethoxyethyl silane, diethoxydiethyl silane, ethoxytriethyl silane, tetra-iso-propoxy silane, di-iso-propoxy di-iso-propyl silane, tetrapropoxy silane, dipropoxydipropyl silane, tetrabutoxy silane, dibutoxydibutyl silane, dicyclopentoxy diethyl silane, diethoxydiphenyl silane, cyclohexyloxy trimethyl silane, phenoxytrimethyl silane, tetraphenoxy silane, triethoxyphenyl silane, hexamethyl disiloxane, hexaethyl disiloxane, hexapropyl disiloxane, octaethyl trisiloxane, dimethylpolysiloxane, diphenylpolysiloxane, methylhydropolysiloxane, phenylhydropolysiloxane, and the like.

The organic silicon compound having Si—O bond (i) is preferably a compound represented by the general formula of Si(OR¹⁰)ₜR¹¹₄₋ₜ (wherein t is preferably a number satisfying 1<t≦4), particularly preferred is tetraalkoxy silane wherein t=4, and the most preferred is tetraethoxy silane.

In the titanium compound (ii) represented by the above general formula [I], R² is a hydrocarbon group having 1 to 20 carbon atoms. R² includes, for example, an alkyl group such as methyl, ethyl, propyl, isopropyl, butyl, isobutyl, amyl, isoamyl, hexyl, heptyl, octyl, decyl and dodecyl; an aryl group such as phenyl, cresyl, xylyl and naphthyl; a cycloalkyl group such as cyclohexyl and cyclopenthyl; an allyl group such as propenyl; and an aralkyl group such as benzyl.

The hydrocarbon group having 1 to 20 carbon atoms is preferably an alkyl group having 2 to 18 carbon atoms or an aryl group having 6 to 18 carbon atoms, more preferably a linear alkyl group having 2 to 18 carbon atoms.

In the titanium compound (ii) represented by the above general formula [I], each of X² is a halogen atom or a hydrocarbonoxy group having 1 to 20 carbon atoms. The halogen atom in X² includes, for example, a chlorine atom, a bromine atom and an iodine atom, and particularly preferred is a chlorine atom. The hydrocarbonoxy group having 1 to 20 carbon atoms in X² is a hydrocarbonoxy group having a hydrocarbon group having 1 to 20 carbon atoms as well as in R². Particularly preferred X² is an alkoxy group having a linear alkyl group having 2 to 18 carbon atoms.

In the titanium compound (ii) represented by the above general formula [I], a is a number of 1 to 20, preferably a number satisfying 1≦a≦5.

The titanium compound (ii) includes, for example, tetramethoxy titanium, tetraethoxy titanium, tetra-n-propoxy titanium, tetra-iso-propoxy titanium, tetra-n-butoxy titanium, tetra-iso-butoxy titanium, n-butoxy titanium trichloride, di-n-butoxy titanium ditrichloride, tri-n-butoxy titanium chloride, di-n-tetraisopropyl polytitanate (a mixture having a range of a=2 to 10), tetra-n-butyl polytitanate (a mixture having a range of a=2 to 10), tetra-n-hexyl polytitanate (a mixture having a range of a=2 to 10), tetra-n-octyl polytitanate (a mixture having a range of a=2 to 10) and the like.

Additionally, the titanium compound (ii) can include a condensation product of tetraalkoxy titanium prepared by reacting tetraalkoxy titanium with a small amount of water.

The titanium compound (ii) is preferably a titanium compound wherein a is a number of 1, 2 or 4 in the formula [I]. Particularly preferable titanium compound (ii) is tetra-n-butoxy titanium, tetra-n-butyl titanium dimer or tetra-n-butyl titanium tetramer. One kind or a mixture of plural kinds of the titanium compound (ii) can be used.

The organic magnesium compound (iii) is any kinds of organic magnesium compound having a magnesium-carbon bond. Particularly, the organic magnesium compound (iii) is preferably a Grignard compound represented by the general formula of R¹⁶MgX⁵ (in the formula, Mg stands for a magnesium atom, R¹⁶ stands for a hydrocarbon group having 1 to 20 carbon atoms, and X⁵ stands for a halogen atom) or dihydrocarbyl magnesium represented by the general formula of R¹⁷R¹⁸Mg (in the formula, Mg stands for a magnesium atom, and each of R¹⁷ and R¹⁸ stands for a hydrocarbon group having 1 to 20 carbon atoms). In the above formula, R¹⁷ and R¹⁸ may be the same or different with each other. Each of R¹⁶, R¹⁷ and R¹⁸ includes, for example, an alkyl group, an aryl group, an aralkyl group and an alkenyl group each having 1 to 20 carbon atoms such as methyl, ethyl, propyl, isopropyl, butyl, sec-butyl, tert-butyl, isoamyl, hexyl, octyl, 2-ethylhexyl, phenyl and benzyl. Particularly, a solution of the Grignard compound represented by the general formula of R¹⁶MgX⁵ in ether is preferred in terms of polymerization activity.

The halogenated compound (b) includes, for example, titanium tetrachloride, methyl aluminum dichloride, ethyl aluminum dichloride, tetrachloro silane, phenyltrichloro silane, methyltrichloro silane, ethyltrichloro silane, n-propyltrichloro silane, and tin tetrachloride, in terms of polymerization activity. One kind or plural kinds of the halogenated compound (b) can be used simultaneously or successively.

The phthalic acid derivative (c) includes, for example, diethyl phthalate, di-n-butyl phthalate, di-iso-butyl phthalate, di-iso-heptyl phthalate, di(2-ethylhexyl)phthalate and diisodecyl phthalate.

Furthermore, when multistage polymerization is carried out with plural reaction vessels by use of one kind of a polymerization catalyst, polymerization conditions in at least one reaction vessel among plural reaction vessels are preferably those which give an intrinsic viscosity of not less than 3 to the ethylene-based resin obtained by conducting polymerization using the catalyst used under the polymerization conditions in the reaction vessel. Moreover, it is preferable to polymerize so that the proportion of a high molecular weight component polymerized under polymerization reaction conditions giving the high molecular weight component contained in the ethylene-based resin of the present invention can be not less than 0.5 weight % and not more than 10 weight %, from the viewpoint of processability and transparency of a molded object obtained by use of the resin.

Furthermore, when multistage polymerization is carried out by use of one kind of a polymerization catalyst, the degree of short chain branching (the number of branches per 1,000 carbons) in a resin component obtained in a polymerization tank giving a high molecular weight component is preferably not less than 6 and not more than 20, from the viewpoint of transparency of a molded object obtained by use of the ethylene-based resin of the present invention.

When the ethylene-based resin of the present invention is produced with two or more kinds of polymerization catalysts containing a polymerization catalyst giving a high molecular weight component and a polymerization catalyst giving a low molecular weight component, the respective suitable catalysts include the following ones.

The polymerization catalyst giving a high molecular weight component includes, for example, a transition metal compound polymerization catalyst represented by the undermentioned general formula (II), and the like.

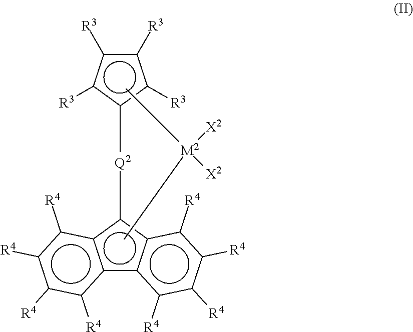

In the formula, M² stands for a transition metal atom of the 4th group in the periodic table of the elements, X² stands for a halogen atom or a hydrocarbonoxy group having 1 to 20 carbon atoms and all X² may be the same or different with each other, R³ and R⁴ respectively stand for independently hydrogen atom, a halogen atom, a hydrocarbyl group having 1 to 20 carbon atoms, which may be substituted, a hydrocarbyloxy group having 1 to 20 carbon atoms, which may be substituted, a substituted silyl group having 1 to 20 carbon atoms, or a substituted amino group having 1 to 20 carbon atoms, plural X² may be the same or different with each other, plural R³ may be the same or different one another, plural R⁴ may be the same or different one another, and Q² stands for a cross-linking group represented by the undermentioned general formula (III).

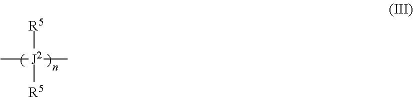

In the formula, n is an integer of 1 to 5, J² stands for an atom of the 14th group in the periodic table of the elements, R⁵ is hydrogen atom, a halogen atom, a hydrocarbyl group having 1 to 20 carbon atoms, which may be substituted, a hydrocarbyloxy group having 1 to 20 carbon atoms, which may be substituted, a substituted silyl group having 1 to 20 carbon atoms, or a substituted amino group having 1 to 20 carbon atoms, and plural R⁵ may be the same or different with each other.

In the general formula (II), M² stands for a transition metal atom of the 4th group in the periodic table of the elements, and includes, for example, a titanium atom, a zirconium atom, hafnium atom, and the like.

In the general formula (II), X² includes, for example, chlorine atom, methyl, ethyl, n-propyl, isopropyl, n-butyl, methoxy, ethoxy, n-propoxy, isopropoxy, n-butoxy, phenyl and phenoxy.

In the general formula (II), R³ and R⁴ independently includes, for example, a hydrogen atom and an alkyl group having 1 to 6 carbon atoms, preferably a hydrogen atom and an alkyl group having 1 to 4 carbon atoms, more preferably a hydrogen atom.

In the above general formula (III) which stands for a cross-linking group Q², J² stands for an atom of the 14th group in the periodic table of the elements and includes, for example, carbon atom, silicon atom, germanium atom and the like, preferably carbon atom and silicon atom. In the above general formula (III) which stands for a cross-linking group Q², R⁵ is hydrogen atom, a halogen atom, a hydrocarbyl group having 1 to 20 carbon atoms, which may be substituted, a hydrocarbyloxy group having 1 to 20 carbon atoms, which may be substituted, a substituted silyl group having 1 to 20 carbon atoms, or a substituted amino group having 1 to 20 carbon atoms, and plural R⁵ may be the same or different with each other.

The cross-linking group Q² represented by the above general formula (III) includes, for example, methylene group, ethylene group, isopropylidene group, bis(cyclohexyl)methylene group, diphenylmethylene group, dimethylsilanediyl group, and bis(dimethylsilane)diyl group, more preferably diphenylmethylene group.

On the one hand, the polymerization catalyst giving a low molecular weight component includes, for example, a transition metal compound polymerization catalyst having as a central metal a transition metal atom of the 4th group and having two groups with substituent-containing cyclopentadiene type anionic skeletons, the groups with cyclopentadiene type anionic skeletons being not bonded with each other, and the like. When a polymerization catalyst component having cyclopentadiene type anionic skeletons, which are bonded with each other, is used, the resultant polymer has long chain branches, and its strength tends to decrease. The transition metal atom of the 4th group includes, for example, a titanium atom, a zirconium atom, hafnium atom, and the like.

Furthermore, with regard to a mixing molar ratio of the polymerization catalyst giving a high molecular weight component (Cat. 1) and the polymerization catalyst giving a low molecular weight component (Cat. 2), Cat. 1:Cat. 2=x:y, it is preferable to satisfy the following conditions. When polymerization activity (g/g) per g of each of Cat. 1 and Cat. 2 obtained by conducting polymerization by use of each catalyst singly under the same polymerization conditions as those at the time of polymerization using the mixed catalyst components is assumed as A_{Cat1} and A_{Cat2} respectively, A_{Cat1}·x/A_{Cat2}·Y is preferably not less than 0.005 from the viewpoint of enhancing transparency of the resultant ethylene-based resin. Moreover, A_{Cat1}·x/A_{Cat2}·y is preferably not more than 0.12 from the viewpoint of processability.

Conditions in producing the ethylene-based resin of the present invention by use of the polymerization catalyst giving a high molecular weight component (Cat. 1) and the polymerization catalyst giving a low molecular weight component (Cat. 2), are preferably those which give an intrinsic viscosity [η] of not less than 3 to the ethylene-based resin obtained by conducting polymerization by use of Cat. 1 under the same polymerization conditions as those at the time of polymerization using the mixed catalyst components.

In the case of using a metallocene catalyst as a polymerization catalyst component, a publicly-known co-catalyst component for activation, a carrier, and the like can be used in combination therewith.

The ethylene-based resin of the present invention can be used for various moldings, as needed, together with another resin. The other resin includes an ethylene-based resin different from the ethylene-based resin of the present invention.

The ethylene-based resin of the present invention may contain a publicly-known additive, as needed. The additive includes, for example, antioxidant, weathering agent, lubricant, antiblocking agent, antistatic agent, anti-fogging agent, anti-dropping agent, pigment, filler, and the like.

The ethylene-based resin of the present invention is molded into film, sheet, bottle, tray, or the like by a publicly-known molding method, for example, extrusion molding method such as blown film molding method or flat-die film molding method, blow molding method, injection molding method, compression molding method, or the like. As the molding method, extrusion molding method is preferably used. In addition, the ethylene-based resin of the present invention is preferably molded into a film, which is used.

In the case of producing a film by extrusion molding of the ethylene-based resin of the present invention, for example, it is possible to melt and knead the ethylene-based resin in an extruder set at 160 to 220° C., extrude it from a circular die set at 180 to 240° C., and conduct blown film molding at a blow-up ratio of 1 to 4.

The ethylene-based resin of the present invention is excellent in transparency and impact strength, and molded objects produced by molding the ethylene-based resin are used for various uses such as food packaging, surface protection, and the like.

### EXAMPLES

Hereinafter, the present invention is illustrated by way of Examples and Comparative Examples.

Physical properties in Examples and Comparative Examples were measured in accordance with the following methods.

(1) Density (Unit: kg/m³)

Density was measured in accordance with the underwater substitution method as stipulated in JIS K7112-1980. In addition, the sample was subjected to the annealing as stated in JIS K6760-1995.

(2) Melt Flow Rate (MFR, Unit: g/10 min)

Melt flow rate was measured by A method under the conditions of 21.18 N load and 190° C. temperature in accordance with the method as stipulated in JIS K7210-1995.

(3) Intrinsic Viscosity ([η], Unit: dl/g)

There were prepared a tetralin solution (hereinafter referred to as the blank solution), wherein 2,6-di-t-butyl-p-cresol (BHT) was dissolved at a concentration of 0.5 g/L, and a solution (hereinafter referred to as a sample solution), wherein a resin was dissolved in the blank solution so as to give a concentration of 1 mg/ml. By use of an Ubbelohde type viscometer, fall times of the blank solution and a sample solution at 135° C. were measured. Intrinsic viscosity [η] was calculated in accordance with the following formula from the fall times.

[η]=23.3×log(ηrel)
ηrel=fall time of a sample solution/fall time of the blank solution
   (4) Activation Energy of Flow (Ea, Unit: kJ/mol)

By use of a viscoelasticity measuring apparatus (Rheometrics Mechanical Spectrometer RMS-800 manufactured by Rheometrics Co.), there were measured melting complex viscosity-angular frequency curves at 130° C., 150° C., 170° C., and 190° C. under the measurement conditions as mentioned below. Next, from the resultant melting complex viscosity-angular frequency curves, the master curve of melting complex viscosity-angular frequency curve at 190° C. was prepared, and activation energy of flow (Ea) was calculated, by use of the calculation software, Rhios V.4.4.4 manufactured by Rheometrics Co.

<Measurement Conditions>
Geometry: parallel plates
Plate diameter: 25 mm
Distance between plates: 1.5 to 2 mm
Strain: 5%
Angular frequency: 0.1 to 100 rad/sec
Measurement atmosphere: nitrogen

### (5) Molecular Weight Distribution (Mw/Mn, Mz/Mw)

Z average molecular weight (Mz), weight average molecular weight (Mw), and number average molecular weight (Mn) were measured by use of gel permeation chromatograph (GPC) method under the undermentioned conditions (i) to (Viii), and Mw/Mn and Mz/Mw were calculated. As the base line on chromatogram, there was used a straight line produced by connecting the point of a stable horizontal area sufficiently shorter in retention time than appearance of a sample elution peak and the point of a stable horizontal area sufficiently longer in retention time than observation of a solvent elution peak.
(i) Apparatus: Waters 150C manufactured by Waters & Co.
(ii) Separation columns: two TOSOH TSK gel GMH6-HT
(iii) Measurement temperature: 152° C.
(iv) Carrier: ortho-dichlorobenzene
(v) Flow rate: 1.0 mL/min
(vi) Poured Amount: 500 μL
(vii) Detector: differential refractometer
(viii) Molecular weight standard substance: standard polystyrene

### (6) Transparency of Film

Haze of a film was measured in accordance with ASTM 1003. The smaller the haze, the better the transparency of the film.

### (7) Impact Strength of Film

By use of a film impact tester with a temperature controlled bath (manufactured by Toyo Seiki Co., Ltd.), and under the conditions that the perforating portion shape of the pendulum end is a hemisphere of 15 mm φ and that the effective area of a test piece is a circular form of 50 mm φ, impact perforation strength of a film at 23° C. was measured.

### (8) Measurement of a Resin Amount Eluted at 100° C. or More as Measured by Temperature a Rise Elution Fractionation Method

The measurement was carried out by use of the undermentioned apparatus and under the undermentioned conditions.
Apparatus: CFC T150A type manufactured by Mitsubishi Chemical Corp.
Detector: Magna-IR550 manufactured by Nicolet Japan Corp.
Wavelength: data range, 2982 to 2842 cm⁻¹
Columns: two UT-806M manufactured by Showa Denko K.K.
Solvent: ortho-dichlorobenzene
Flow rate: 60 ml/hour
Sample concentration: 100 mg/25 ml
Amount of sample poured: 0.8 ml
Support condition: Temperature was lowered from 140° C. to 0° C. at the rate of 1° C./min, and then leaving to stand was conducted for 30 minutes, and elution was initiated from 0° C. fraction.
Condition for obtaining data: Elution data were obtained in 0° C., 30° C., 60° C. and 80° C. In the temperature range of 85° C. to 105° C., data of eluted amount were obtained at an interval of 1° C. up to at least 100° C. until no elution was observed, and subsequently temperature was raised to 140° C. and then datum of eluted amount was obtained.

### Example 1

### (1) Preparation of Component (A1)

### (1-1) Preparation of Solid Catalyst Component

Into a nitrogen-substituted 200 L reactor provided with a stirrer and a baffle board, 80 L of hexane, 20.6 kg of tetraethoxysilane, and 2.2 kg of tetrabutoxytitanium were charged and stirred. Next, into the above stirred mixture, 50 L of dibutyl ether solution (concentration 2.1 mol/L) of butylmagnesium chloride was dropped in 4 hours, while keeping the temperature of the reactor at 5° C. After completion of dropping, the mixture was stirred for 1 hour at 5° C. and furthermore for 1 hour at 20° C., and filtered to obtain a solid component. Subsequently the resultant solid component was washed three times with 70 L of toluene, and 63 L of toluene was added to the solid component to obtain a slurry.

A reactor provided with a stirrer and having an inner volume of 210 L was replaced with nitrogen, the toluene slurry of solid component was charged into the reactor, and 14.4 kg of tetrachlorosilane and 9.5 kg of di(2-ethylhexyl)phthalate were charged therein and stirred for 2 hours at 105° C. Next, solid-liquid separation was conducted, and the resultant solid was washed three times with 90 L of toluene at 95° C. To the solid was added 63 L of toluene, temperature was raised to 70° C., 13.0 kg of TiCl₄ was charged therein, and stirring was conducted for 2 hours at 105° C. Subsequently, solid-liquid separation was conducted, and the resultant solid was washed six times with 90 L of toluene at 95° C. and furthermore washed twice with 90 L of hexane at room temperature. The solid after washing was dried to obtain a solid catalyst component.

### (1-2) Preparation of Prepolymerized Catalyst (XA-1)

An autoclave with a stirrer having an inner volume of 3 L was sufficiently dried and vacuumized, and 490 g of butane and 260 g of 1-butene were charged therein and temperature was raised to 55° C. Next, ethylene was added thereto so as to give a partial pressure of 1.0 MPa. Thereinto, 5.4 millimoles of triethylaluminium and 326.4 mg of the solid catalyst component produced in (1-1) of Example 1 were charged under pressure with argon to initiate polymerization. Ethylene was continuously fed therein from a steel bottle so as to make the pressure constant, and polymerization was carried out at 55° C. until the weight decrease amount of the steel bottle became 48.9 g. After polymerization, feeding of ethylene was stopped, the inside of the system was purged and then pressurized with argon gas, and prepolymerized powders were collected into a nitrogen-substituted ampoule, which was sealed. For a portion of the collected prepolymerized powders, intrinsic viscosity [η] was measured and degree of short chain branching was assayed with IR to obtain [η] of 9.1 and degree of short chain branching per 1,000 carbons of 10.4.

### (1-3) Main Polymerization

An autoclave with a stirrer having an inner volume of 3 L was sufficiently dried and vacuumized, and 620 g of butane and 130 g of 1-butene were charged therein and temperature was raised to 70° C. Next, ethylene was added thereto so as to give a partial pressure of 0.6 MPa, and hydrogen was added thereto so as to give a partial pressure of 0.2 MPa. Thereinto, 1.7 millimoles of triethylaluminium and 3.75 g of the prepolymerized catalyst (XA-1) produced in (1-2) were charged under pressure with argon to initiate polymerization. Ethylene was continuously fed therein from a steel bottle so as to make the pressure constant, and polymerization was carried out for 3 hours at 70° C. By the polymerization, there was obtained 197 g of an ethylene-1-butene copolymer (hereinafter, referred to as ethylene-based resin (A1)). Physical property values of the copolymer (A1) were shown in Table 1.

### (2) Film Molding

In the ethylene-based resin (A1), were incorporated 1,000 ppm of an antioxidant (Sumirizer GP manufactured by Sumitomo Chemical Co., Ltd.) and 800 ppm of calcium stearate, and by use of a blown film molding machine (single screw extruder (diameter: 15 mm φ) manufactured by Randcastle Co., its dice have a die diameter of 15.9 mm φ and a lip gap of 2.0 mm), and under the molding conditions of molding temperature: 200° C., extrusion rate: 150 g/hr, frost line height: 20 mm, blow ratio: 2.0, and film-taking-out speed: 2.2 m/min, was molded a blown film having a thickness of 20 μm. The evaluation results of physical properties of the resultant film were shown in Table 2.

### Example 2

### (1) Preparation of Component (A2)

### (1-1) Preparation of Prepolymerized Catalyst (XA-2)

An autoclave with a stirrer having an inner volume of 3 L was sufficiently dried and vacuumized, and 550 g of butane and 200 g of 1-butene were charged therein and temperature was raised to 55° C. Next, ethylene was added thereto so as to give a partial pressure of 0.6 MPa. Thereinto, 1.7 millimoles of triethylaluminium and 193.7 mg of the solid catalyst component produced in (1-1) of Example 1 were charged under pressure with argon to initiate polymerization. Ethylene was continuously fed therein from a steel bottle so as to make the pressure constant, and polymerization was carried out at 55° C. until the weight decrease amount of the steel bottle became 19.0 g. After polymerization, feeding of ethylene was stopped, the inside of the system was purged and then pressurized with argon gas, and prepolymerized powders were collected into a nitrogen-substituted ampoule, which was sealed. For a portion of the collected prepolymerized powders, intrinsic viscosity [η] was measured and degree of short chain branching was assayed with IR to obtain [η] of 8.1 and degree of short chain branching per 1,000 carbons of 11.5.

### (1-2) Main Polymerization

An autoclave with a stirrer having an inner volume of 3 L was sufficiently dried and vacuumized, and 530 g of butane and 105 g of 1-butene were charged therein and temperature was raised to 70° C. Next, ethylene was added thereto so as to give a partial pressure of 0.5 MPa, and hydrogen was added thereto so as to give a partial pressure of 0.2 MPa. Thereinto, 1.7 millimoles of triethylaluminium and 4.44 g of the prepolymerized catalyst (XA-2) produced in (1-1) were charged under pressure with argon to initiate polymerization. Ethylene was continuously fed therein from a steel bottle so as to make the pressure constant, and polymerization was carried out for 2 hours at 70° C. By the polymerization, there was obtained 208.5 g of an ethylene-1-butene copolymer (hereinafter, referred to as ethylene-based resin (A2)). Physical property values of the ethylene-based resin (A2) were shown in Table 1.

### (2) Film Molding

A blown film was molded similarly to Example 1, except that the ethylene-based resin (A2) was used in place of the ethylene-based resin (A1). The evaluation results of physical properties of the resultant film were shown in Table 2.

### Example 3

### (1) Preparation of Component (A3)

### (1-1) Preparation of Prepolymerized Catalyst (XA-3)

An autoclave with a stirrer having an inner volume of 3 L was sufficiently dried and vacuumized, and 502 g of butane and 262 g of 1-butene were charged therein and temperature was raised to 70° C. Next, ethylene was added thereto so as to give a partial pressure of 0.6 MPa. Thereinto, 1.7 millimoles of triethylaluminium and 223.3 mg of the solid catalyst component produced in (1-1) of Example 1 were charged under pressure with argon to initiate polymerization. Ethylene was continuously fed therein from a steel bottle so as to make the pressure constant, and polymerization was carried out at 70° C. until the weight decrease amount of the steel bottle became 65.5 g. After polymerization, feeding of ethylene was stopped, the inside of the system was purged and then pressurized with argon gas, and prepolymerized powders were collected into a nitrogen-substituted ampoule, which was sealed. For a portion of the collected prepolymerized powders, intrinsic viscosity [η] was measured to obtain [η] of 4.9.

### (1-2) Main Polymerization

An autoclave with a stirrer having an inner volume of 3 L was sufficiently dried and vacuumized, and 620 g of butane and 130 g of 1-butene were charged therein and temperature was raised to 70° C. Next, ethylene was added thereto so as to give a partial pressure of 0.6 MPa, and hydrogen was added thereto so as to give a partial pressure of 0.3 MPa. Thereinto, 1.7 millimoles of triethylaluminium and 3.81 g of the prepolymerized catalyst (XA-3) produced in (1-1) were charged under pressure with argon to initiate polymerization. Ethylene was continuously fed therein from a steel bottle so as to make the pressure constant, and polymerization was carried out for 2 hours at 70° C. By the polymerization, there was obtained 62 g of an ethylene-1-butene copolymer (hereinafter, referred to as ethylene-based resin (A3)). Physical property values of the ethylene-based resin (A3) were shown in Table 1.

### (2) Film Molding

A blown film was molded similarly to Example 1, except that the ethylene-based resin (A3) was used in place of the ethylene-based resin (A1). The evaluation results of physical properties of the resultant film were shown in Table 2.

### Example 4

### (1) Preparation of Component (A4)

### (1-1) Preparation of Prepolymerized Catalyst (XA-4)

An autoclave with a stirrer having an inner volume of 3 L was sufficiently dried and vacuumized, and 490 g of butane and 260 g of 1-butene were charged therein and temperature was raised to 55° C. Next, ethylene was added thereto so as to give a partial pressure of 1.0 MPa. Thereinto, 1.7 millimoles of triethylaluminium and 194.4 mg of the solid catalyst component produced in (1-1) of Example 1 were charged under pressure with argon to initiate polymerization. Ethylene was continuously fed therein from a steel bottle so as to make the pressure constant, and polymerization was carried out at 55° C. until the weight decrease amount of the steel bottle became 70.0 g. After polymerization, feeding of ethylene was stopped, the inside of the system was purged and then pressurized with argon gas, and prepolymerized powders were collected into a nitrogen-substituted ampoule, which was sealed. For a portion of the collected prepolymerized powders, intrinsic viscosity [η] was measured and degree of short chain branching was assayed with IR to obtain [η] of 12.5 and degree of short chain branching per 1,000 carbons of 6.9.

### (1-2) Main Polymerization

An autoclave with a stirrer having an inner volume of 3 L was sufficiently dried and vacuumized, and 620 g of butane and 130 g of 1-butene were charged therein and temperature was raised to 70° C. Next, ethylene was added thereto so as to give a partial pressure of 0.6 MPa, and hydrogen was added thereto so as to give a partial pressure of 0.25 MPa. Thereinto, 1.7 millimoles of triethylaluminium and 5.40 g of the prepolymerized catalyst (XA-4) produced in (1-1) were charged under pressure with argon to initiate polymerization. Ethylene was continuously fed therein from a steel bottle so as to make the pressure constant, and polymerization was carried out for 3.5 hours at 70° C. By the polymerization, there was obtained 92 g of an ethylene-1-butene copolymer (hereinafter, referred to as ethylene-based resin (A4)). Physical property values of the ethylene-based resin (A4) were shown in Table 1.

### (2) Film Molding

A blown film was molded similarly to Example 1, except that the ethylene-based resin (A4) was used in place of the ethylene-based resin (A1). The evaluation results of physical properties of the resultant film were shown in Table 2.

### Example 5

### (1) Preparation of Component (A5)

An autoclave with a stirrer having an inner volume of 3 L was sufficiently dried and vacuumized, and 620 g of butane and 130 g of 1-butene were charged therein and temperature was raised to 70° C. Next, ethylene was added thereto so as to give a partial pressure of 0.6 MPa, and hydrogen was added thereto so as to give a partial pressure of 0.2 MPa. Thereinto, 1.7 millimoles of triethylaluminium and 6.9 g of the prepolymerized catalyst (XA-3) produced in (1-1) of Example 3 were charged under pressure with argon to initiate polymerization. Ethylene was continuously fed therein from a steel bottle so as to make the pressure constant, and polymerization was carried out for 3 hours at 70° C. By the polymerization, there was obtained 144 g of an ethylene-1-butene copolymer (hereinafter, referred to as ethylene-based resin (A5)). Physical property values of the ethylene-based resin (A5) were shown in Table 1.

### (2) Film Molding

A blown film was molded similarly to Example 1, except that the ethylene-based resin (A5) was used in place of the ethylene-based resin (A1). The evaluation results of physical properties of the resultant film were shown in Table 2.

### Comparative Example 1

### (1) Preparation of Component (A6)

### (1-1) Preparation of Prepolymerized Catalyst (XA-6)

An autoclave with a stirrer having an inner volume of 3 L was sufficiently dried and vacuumized, and 750 g of butane was charged therein and temperature was raised to 70° C. Next, ethylene was added thereto so as to give a partial pressure of 0.6 MPa. Thereinto, 4.6 millimoles of triethylaluminium and 296.4 mg of the solid catalyst component produced in (1-1) of Example 1 were charged under pressure with argon to initiate polymerization. Ethylene was continuously fed therein from a steel bottle so as to make the pressure constant, and polymerization was carried out at 70° C. until the weight decrease amount of the steel bottle became 36.0 g. After polymerization, feeding of ethylene was stopped, the inside of the system was purged and then pressurized with argon gas, and prepolymerized powders were collected into a nitrogen-substituted ampoule, which was sealed. For a portion of the collected prepolymerized powders, intrinsic viscosity [η] was measured to obtain [η] of 9.5.

### (1-2) Main Polymerization

An autoclave with a stirrer having an inner volume of 3 L was sufficiently dried and vacuumized, and 620 g of butane and 130 g of 1-butene were charged therein and temperature was raised to 70° C. Next, ethylene was added thereto so as to give a partial pressure of 0.6 MPa, and hydrogen was added thereto so as to give a partial pressure of 0.3 MPa. Thereinto, 1.7 millimoles of triethylaluminium and 7.95 g of the prepolymerized catalyst (XA-6) produced in (1-1) were charged under pressure with argon to initiate polymerization. Ethylene was continuously fed therein from a steel bottle so as to make the pressure constant, and polymerization was carried out for 75 minutes at 70° C. By the polymerization, there was obtained 170 g of an ethylene-1-butene copolymer (hereinafter, referred to as ethylene-based resin (A6)). Physical property values of the ethylene-based resin (A6) were shown in Table 1.

### (2) Film Molding

A blown film was molded similarly to Example 1, except that the ethylene-based resin (A6) was used in place of the ethylene-based resin (A1). The evaluation results of physical properties of the resultant film were shown in Table 2.

### Comparative Example 2

Film molding was carried out similarly to that of Example 1, except that a linear low-density polyethylene (Sumikasen L FS240 manufactured by Sumitomo Chemical Co., Ltd.: hereinafter referred to as ethylene-based resin (A7). Its physical property values were shown in Table 1.) was used in place of the ethylene-based resin (A1). The evaluation results of physical properties of the resultant film were shown in Table 2.

### Example 6

### (1) Preparation of Component (A8)

### (1-1) Preparation of Prepolymerized Catalyst (XA-7)

An autoclave with a stirrer having an inner volume of 5 L was sufficiently dried and vacuumized, and 1000 g of butane and 200 g of 1-butene were charged therein and temperature was raised to 50° C. Next, ethylene was added thereto so as to give a partial pressure of 0.3 MPa. Thereinto, 6.0 millimoles of triethylaluminium and 525.1 mg of the solid catalyst component produced in (1-1) of Example 1 were charged under pressure with argon to initiate polymerization. Ethylene was continuously fed therein from a steel bottle so as to make the pressure constant. When the weight decrease amount of the steel bottle became 25 g, 0.1 MPa of hydrogen was introduced. Then, ethylene was further continuously fed therein from a steel bottle so as to make the pressure constant. When the weight decrease amount of the steel bottle became 25 g, 0.1 MPa of hydrogen was introduced again. Then, ethylene was further continuously fed therein from a steel bottle so as to make the pressure constant. When the weight decrease amount of the steel bottle became 28 g, feeding of ethylene was stopped, the inside of the system was purged and then pressurized with argon gas, and prepolymerized powders were collected into a nitrogen-substituted ampoule, which was sealed. For a portion of the collected prepolymerized powders, intrinsic viscosity [η] was measured and degree of short chain branching was assayed with IR to obtain [η] of 3.4 and degree of short chain branching per 1,000 carbons of 20.1.

Meanwhile, similar experiment was carried out and, at a first stage that the weight decrease amount of the steel bottle became 25 g for the first time, feeding of ethylene was stopped, the inside of the system was purged and then pressurized with argon gas, and prepolymerized powders were collected into a nitrogen-substituted ampoule, which was sealed. For a portion of the collected prepolymerized powders, intrinsic viscosity [η] was measured and degree of short chain branching was assayed with IR to obtain [η] of 7.3 and degree of short chain branching per 1,000 carbons of 24.1.

### (1-2) Main Polymerization

An autoclave with a stirrer having an inner volume of 5 L was sufficiently dried and vacuumized, and 1033 g of butane, 217 g of 1-butene and 6.7 millimoles of triethylaluminium were charged therein and temperature was raised to 70° C. Next, hydrogen was added thereto so as to give a partial pressure of 0.2 MPa, and ethylene was added thereto so as to give a partial pressure of 0.6 MPa. Thereinto, 2.8 millimoles of triethylaluminium and 10.7 g of the prepolymerized catalyst (XA-7) produced in (1-1) were charged under pressure with argon to initiate polymerization. Ethylene was continuously fed therein from a steel bottle so as to make the pressure constant, and polymerization was carried out for 60 minutes at 70° C. By the polymerization, there was obtained 171 g of an ethylene-1-butene copolymer (hereinafter, referred to as ethylene-based resin (A8)). Physical property values of the ethylene-based resin (A8) were shown in Table 1.

### (2) Film Molding

A blown film was molded similarly to Example 1, except that the ethylene-based resin (A8) was used in place of the ethylene-based resin (A1). The evaluation results of physical properties of the resultant film were shown in Table 2.

TABLE 1

| | | | | Proportion of | | | |
|---|---|---|---|---|---|---|---|
| | | | | component eluted | | | |
| | Density | MFR | Ea | at 100° C. or more | Mz/Mw | Mw/Mn | Mz/Mw/ |
| Resin | (kg/m³) | (g/10 min) | (kJ/mol) | (wt %) | (—) | (—) | Mw/Mn |
| A1 | 922 | 0.7 | 31 | 0 | 3.7 | 3.9 | 0.95 |
| A2 | 920 | 3.3 | 33 | 0 | 9.0 | 4.5 | 2.0 |
| A3 | 923 | 1.7 | 32 | 0 | 6.1 | 4.1 | 1.49 |
| A4 | 923 | 0.8 | 29 | 0 | 18.8 | 7.5 | 2.51 |
| A5 | 919 | 0.8 | 28 | 0 | 15.1 | 5.1 | 2.96 |
| A6 | 920 | 2.1 | 31 | 4.4 | 4.7 | 4.0 | 1.18 |
| A7 | 920 | 2 | 30 | 0 | 2.4 | 3.3 | 0.73 |
| A8 | 917 | 0.8 | 28 | 0 | 4.5 | 4.1 | 1.10 |

TABLE 2

| Physical | Example | Example | Example | Example | Example | Comparative | Comparative | Example |
|---|---|---|---|---|---|---|---|---|
| properties of film | 1 | 2 | 3 | 4 | 5 | Example 1 | Example 2 | 6 |
| Haze (%) | 13.1 | 27.2 | 13.8 | 21.3 | 6.9 | 34 | 43 | 13.6 |
| Impact perforation | 80 | 77 | 160 | 41 | 49 | 65 | 78 | 250 |
| strength (kg · cm/mm) | | | | | | | | |

1. An ethylene-based resin satisfying all of the following conditions:
(a) its density ranges from 890 to 930 kg/m³,
(b) its melt flow rate (MFR) ranges from 0.1 to 10 g/10 min,
(c) its activation energy (Ea) of flow is less than 50 kJ/mol,
(d) its Mz/Mw is not less than 3.5,
(e) its (Mz/Mw)/(Mw/Mn) is not less than 0.9, and
(f) its proportion of a resin amount eluted at 100° C. or more as measured by a temperature rise elution fractionation method is less than 1 wt %, provided that a total amount of the ethylene-based resin eluted up to 140° C. is 100 wt %.

2. A film produced by an extrusion molding of the ethylene-based resin according to claim 1.
